(19) United States
(12) Patent Application Publication
(10) Pub. No.: US 2019/0258747 A1
(43) Pub. Date: Aug. 22, 2019

(54) INTERACTIVE DIGITAL TWIN

(71) Applicant: General Electric Company, Schenectady, NY (US)

(72) Inventor: Roberto MILEV, Walnut Creek, CA (US)

(21) Appl. No.: 15/902,027

(22) Filed: Feb. 22, 2018

(51) Int. Cl. G06F 17/30; G10L 15/22; G10L 13/00

(52) U.S. Cl. CPC G06F 17/30979; G10L 13/00; G10L 15/22; G06F 17/30967

(57) ABSTRACT

The example embodiments are directed to an interactive digital twin capable of receiving queries and communicating with a user. In one example, a method includes receiving a query input from a user via a user device, the query input including a request for information from a digital twin executing on a host platform, identifying context of the digital twin that is associated with the query input, the context including information that is unique to an operating state of the digital twin, determining a response to the query input based on the identified context that is unique to the operating state of the digital twin, and outputting the determined response from the digital twin via a communication channel that is capable of being received by the user.

### BACKGROUND

Machine and equipment assets are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include devices that aid in diagnosing patients such as imaging devices (e.g., X-ray or MRI systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

In an industrial operating environment, a digital representation of an asset, referred to as a digital twin, can be made up of a variety of operational technology (OT) and information technology (IT) data management systems. Examples of OT data systems include data historian services which maintain a history of sensor data streams from sensors attached to an asset and monitoring systems that detect and store alerts and alarms related to potential fault conditions of an asset. Examples of IT data systems include enterprise resource planning (ERP) systems, maintenance record databases, and the like. Each of these systems operates in a narrow information silo with its own semantics, concerns and data storage models.

Typically, a digital twin is used to simulate or otherwise mimic the operation of a physical assets within a virtual world. In doing so, the digital twin may virtual display structural components of the asset, show steps in lifecycle and/or design, and be viewable via a user interface. In order to interact with the data being provided by the digital twin, a developer typically develops another piece of software (e.g., an analytic) for gathering information from the twin/asset, performing analysis on the gathered data, and outputting the analysis in some meaningful way. However, at present, for a user to collect knowledge from the digital twin requires the user to sift through significant amounts of information (usually over extended periods of time) in order to make informed decisions. What is needed is an easier way of extracting knowledge from a digital twin.

### SUMMARY

The example embodiments improve upon the prior art by providing an interactive digital twin that can communicate (e.g., via speech, text, gestures, etc.) with a user and provide the user with knowledge and responses to queries and requests. For example, the user may query the digital twin for information via a simple speech command, typed message, or the like, and the digital twin can respond with text, speech, charts, graphs, and other data, within the context of the query provided from the user. In this way, the user and the digital twin may interact with one another as if a conversation were being conducted between two people. Furthermore, the digital twin can also provide visual data output along with speech and text that helps the user quickly and easily grasp the response to the query within the context of the query. As a result, the user requesting information from the digital twin does not need to be familiar with analyzing data reports captured from analyzing a digital twin. In some embodiments, the interactive digital twin may be integrated within an Industrial Internet of Things (IIoT).

According to an aspect of an example embodiment, a computing system may include one or more of a processor configured to receive a query input from a user via a user device, the query input including a request for information from a digital twin executing on a host platform, identify context of the digital twin that is associated with the query input, the context including information that is unique to an operating state of the digital twin, and determine a response to the query input based on the identified context that is unique to the operating state of the digital twin, and an output configured to output the determined response from the digital twin via a communication channel that is capable of being received by the user.

According to an aspect of an example embodiment, a computer-implemented method may include one or more of receiving a query input from a user via a user device, the query input comprising a request for information from a digital twin executing on a host platform, identifying context of the digital twin that is associated with the query input, the context comprising information that is unique to an operating state of the digital twin, determining a response to the query input based on the identified context that is unique to the operating state of the digital twin, and outputting the determined response from the digital twin via a communication channel that is capable of being received by the user.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment in accordance with an example embodiment.

FIG. 2 is a diagram illustrating a system including an interactive digital twin in accordance with an example embodiment.

FIG. 3 is a diagram illustrating a communication sequence between a user and an interactive digital twin in accordance with an example embodiment.

FIG. 4 is a diagram illustrating a method of an interactive digital twin communicating in accordance with an example embodiment.

FIG. 5 is a diagram illustrating a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to an interactive digital twin system. The interactive digital twin is configured to simulate operation of an asset such as a machine, an equipment, a software process, an actor, an information resource, a system of assets, and the like. In addition to generate a simulated representation, the interactive digital twin is also configured to communicate (i.e., converse) with a user via multiple communication channels such as speech (audio), text, gestures (images/video), and the like. For example, the interactive digital twin may receive queries and requests from a user, and generate and output responses within the context of the queries/requests. As one example, the interactive digital twin may receive a query about an issue of an asset being modeled by the interactive digital twin and generate an answer based on context modeled by the digital twin. In addition, the interactive digital twin is capable of communicating with other digital twins to therefore learn from and identify similar operating patterns and issues in other assets, as well as steps taken to resolve those issues.

A user can query the interactive digital twin for information and receive answers to the queries in a form that is easy to understand and that instantly provides knowledge. For example, rather than returning a simple “yes” or “no” or static language description, the twin can output answers identifying issues, components, parts, similar assets, and the like. In addition, the interactive digital twin can output graphs/views or other consumable information that illustrates the behavior/performance of an asset thereby providing the user with an easier and more thorough understanding of what is happening. In an example, the user may interact with the interactive digital twin via a dynamically configured dashboard designed based on various skills of the digital twin. Through the dashboard, a user can ask a digital twin a question and it will provide an answer/data in a consumable form that is user friendly along with additional information and metrics.

Some non-limiting examples of queries that can be submitted to the interactive digital twin include questions about current status of various components of an asset, queries about occurrences to and with the asset over a predetermined period of time (e.g., the past 24 hours, etc.), questions about similar issues that have occurred in the asset or other assets, queries about possible solutions to an issue, and the like. In response, the interactive digital twin can provide declarative responses such as words and/or phrases answering the question asked by the user, information about other issues and conditions that have occurred previously with the asset, similar issues in other assets, and the like.

The concept of a digital twin is well known, but prior digital twin technologies have focused on physics based modeling and machine learning analytics to create operational twins that can be used for failure prediction and error detection. The example embodiments can extend beyond that singular model and include a semantic-based digital twin model (referred to herein as a contextual twin) which can encompass a multiplicity of aspects of an asset, including structural models, physical process models, software process models, as well as modeling other entities in the environment such as people, organizations, facilities, etc. Because the model is semantic in nature, it can encompass hierarchies of assets and rich relationships (i.e., context) between the assets as well as between assets and other entities. The contextual aspect is derived from the further modeling of information, state and condition flows of the asset over time which provide a continual aggregation of knowledge about an asset an its environment. In this way, the contextual digital twin can provide a living model that drives business outcomes.

According to various aspects, the interactive digital twin may be used to virtually model an asset while also modeling context that is associated with the asset. The interactive digital twin may include a virtual representation of an asset which may include a virtual replication of hardware, software, processes, and the like. As an example, an asset may include a physical asset such as a turbine, jet engine, windmill, oil rig, healthcare machine, or the like. As additional examples, an asset may include a software asset (e.g., an application, an analytic, a service, etc.), a system of hardware and/or software (also referred to as a system of things), a physical process, an actor such as a human operator, weather, and the like. According to various aspects, the interactive digital twin may include context of an asset that is incorporated within the virtual representation of the asset.

The context may be determined based on knowledge that is acquired from the asset (or the digital twin of the asset) and that is accumulated over time. For example, a digital twin may generate an alert or other warning based on a change in operating characteristics of the asset. The alert may be due to an issue with a component of the asset. In addition to the alert, the contextual digital twin may generate context that is associated with the alert. For example, the interactive digital twin may determine similar issues that have previously occurred with the asset or on assets that share one or more attributes in common with the asset, provide a description of what caused the issues, what was done to address the issues, and differences between the present issue and the previous issues, etc. As another non-limiting example, the generated context can provide suggestions about actions to take to resolve the current issue.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The interactive digital twin may be used in conjunction with applications and systems for managing machine and equipment assets and can be hosted within an Industrial Internet of Things (IIoT). For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied.

The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a contextual digital twin that is capable of providing context in addition to a virtual representation of an asset. The context can be used to trigger actions, insight, and events based on knowledge that is captured and/or reasoned from the operation of an asset or a group of assets.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

Knowledge may include a correlation or a set of correlations between a multiplicity of information elements, which may be represented as an ontologically defined relationship and which may reflect current or historic state or condition. Knowledge may include information about an asset or a resource, worker, artefact, or the like. A reasoned conclusion (or insight) may be automatically imputed by the system from generated knowledge. As a non-limiting example, an imputation may be that this person has read a particular document from which the assertion that the referenced person is aware of the existence of the particular document can be imputed. A domain event may refer to a particular type of knowledge artifact which models state or status of an entity in time, and which has event specific contextualizing semantics such as “this Actor took this Action with respect to this Entity in accordance with this Business Process at this Time.”

Context may refer to an accumulation of knowledge related to a subject (e.g., an asset, component of the asset, a case involving the asset, an event, etc.) which can be reasoned over to provide subject-specific insight. Context may be generated by acquiring knowledge with an intent to provide a specific solution or set of solutions for a particular problem or issue. As a non-limiting example, context about an asset provided with a digital twin may include insight such as similarly matching events and operations that have previously occurred to the asset (or similar type assets) as well as suggestions about how to handle a current event, and the like.

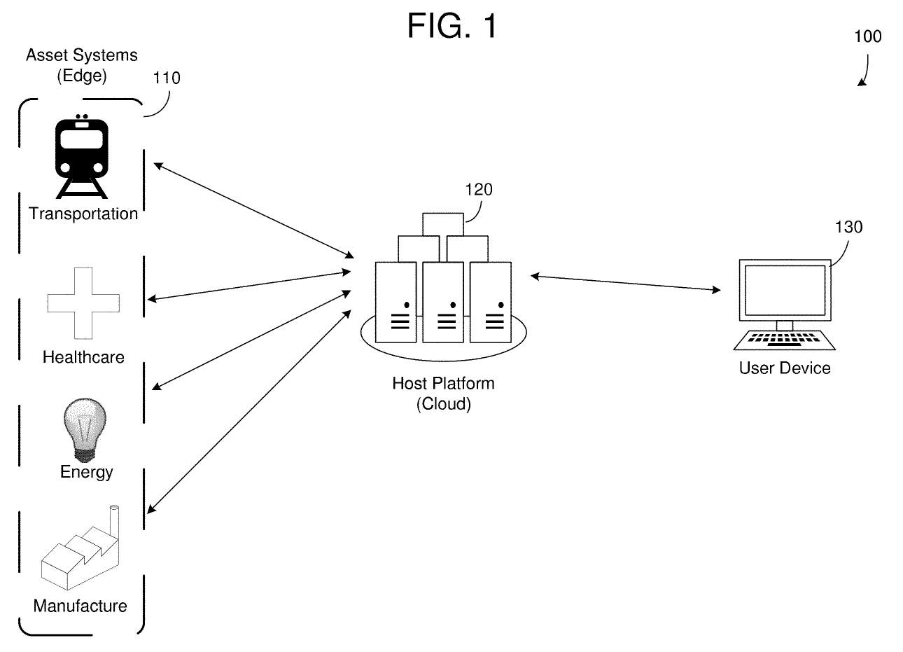

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital model (i.e., an interactive digital twin) of an asset 110 may be generated and stored on the cloud platform 120. The interactive digital twin may be used to virtually represent an operating characteristic of the assets 110. The interactive digital twin may also generate context associated with the operation of the asset 110 and communicate with a user and provide the context in response to specific queries received from the user in a format that is consumable by the user.

The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets) may be hosted by the cloud platform 120 and may interact with the asset. For example, cloud systems may be used to optimize a performance of an asset or data coming in from the asset. As another example, the cloud systems may analyze, control, manage, or otherwise interact with the asset and components (software and hardware) thereof. A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

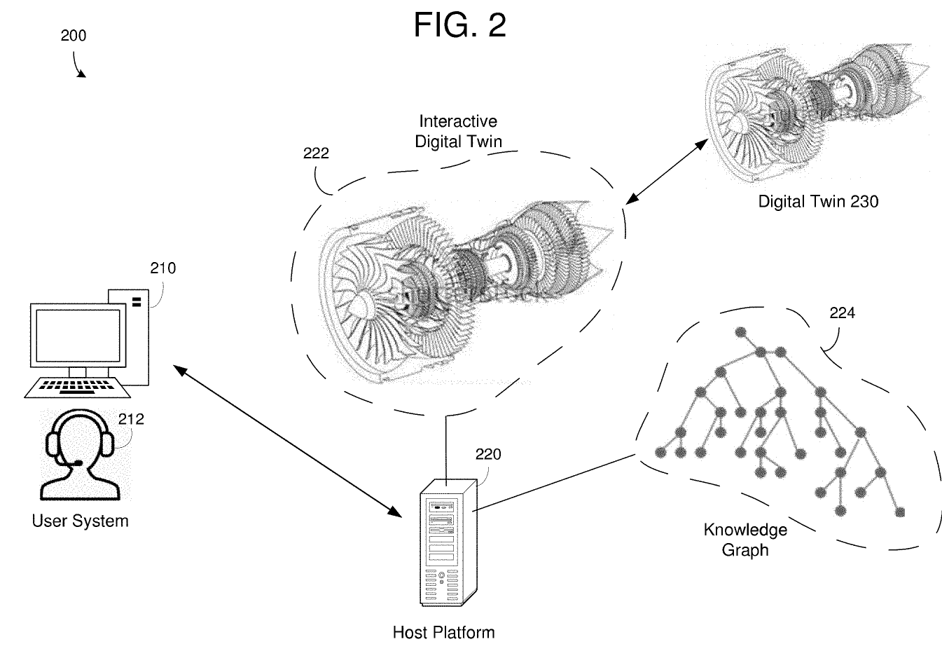

The cloud computing environment 100 shown in FIG. 1 may further include the interactive digital twin system 200 shown in FIG. 2. Referring to FIG. 2, the system 200 includes a user system 210 and a host platform 220. The user system 210 and the host platform 220 may communicate directly (e.g., via a cable) or they may communicate via a network such as a private network, the Internet, and the like. The user system 210 also includes an audio device 212 which can receive speech and output audio to enable a user to submit spoken words and other utterances, and to receive audio. As another example, the user system 210 may be a virtual reality (VR) system, an augmented reality (AR) system, or the like, which distort a view of reality for the user wearing appropriate gear. In this example, the host platform 220 hosts an interactive digital twin 222 and a knowledge graph 224 which represents a template of the interactive digital twin 222. The knowledge graph 224 may include nodes that represent components and sub-components of the asset. Furthermore, the knowledge graph 224 may include links between the nodes that represent relationships between the components and the sub-components of the asset. The interactive digital twin 222 may traverse the knowledge graph 224 to generate a response to a query from the user system 210.

The user system 210 and the host platform 220 may include software enabling the user to communicate directly with the interactive digital twin 222 via a spoken utterance, an input message, a hand gesture, etc., entered via the user system and transmitted to the host platform 220 where it is received by the interactive digital twin 222. In addition to communicating with the user, the interactive digital twin 222 may also communicate with other digital twins (e.g., digital twin 230). In this example, the other digital twin 230 may include a twin of a same type of asset or a different type of asset. The other digital twin 230 may be hosted by the host platform 220 or it may be hosted by another platform and may communicate with the host platform 220 via a network. The other digital twin 230 may have one or more attributes in common with the interactive digital twin 222 such as period of time, a fleet number, a type, a usage, a class of service, a client, or the like.

The user may input queries into user system 210 which are transmitted to the interactive digital twin 222. Some non-limiting examples include queries about what is wrong with an asset being modeled by the interactive digital twin 222, similar issues with other assets, operating conditions of the asset over a predetermined period of time, and the like. The interaction may include a second step which involves a response from the interactive digital twin 222. The response may be declarative and may identify an answer to the user's query. The response may provide the user with context associated with the query such as information about similar issues, operating conditions over a predetermined period of time, activity and patterns of behavior of other assets, and the like, in the form of one or more of spoken words, text, visualizations, and the like.

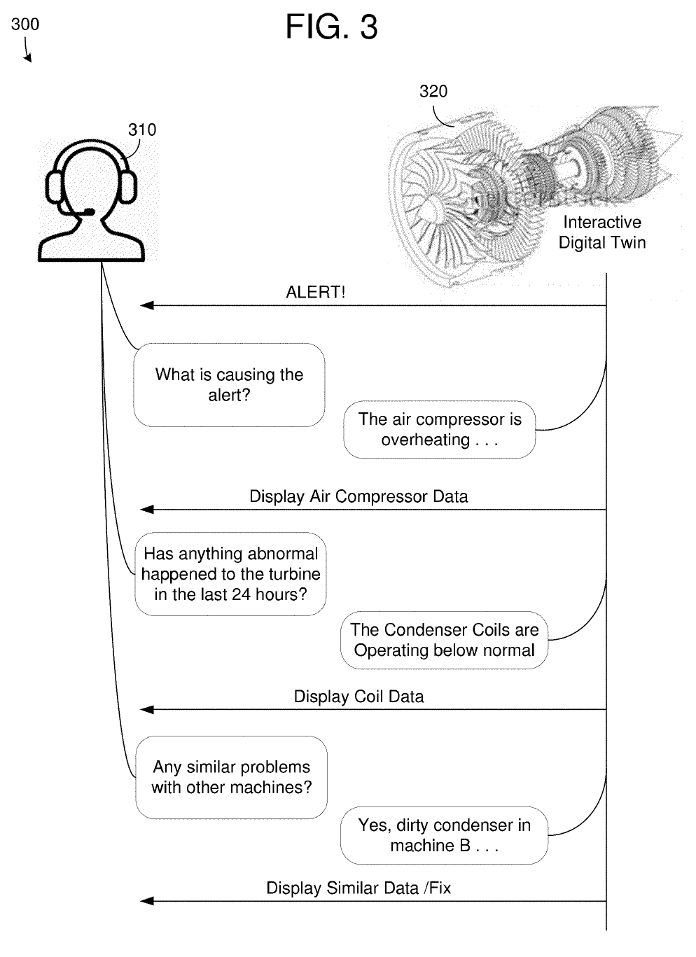

FIG. 3 illustrates a communication sequence 300 between a user 310 (e.g., user system) and an interactive digital twin 320 in accordance with an example embodiment. Ordinarily, a digital twin would display a simulated model of an asset and one or more analytics would analyze data coming from the asset. The analyzed data may be output in the form of tables, charts, graphs, etc. However, such a system requires a user to view the data, comprehend the data, and make insight based on the data. Such a system is only helpful to users that have significant understanding of the asset and the data. One of the advantages provided by the interactive digital twin 320 is that a user can acquire knowledge directly from the interactive digital twin 320 by simply asking questions. As a result, the user does not need to read data from across different periods of time but can simply ask the interactive digital twin 320 for the information. There is a change in the interaction model.

In the communication sequence 300 shown in FIG. 3, the interactive digital twin 320 generates and transmit an alert to the user system 310 indicating that there is a warning or an error associated with an underlying asset being modeled by the interactive digital twin 320. In response, the user submits a query “What is causing the alert?” In response, the interactive digital twin 320 can provide the specific component (or components) that are overheating based on the query submitted by the user. Here, the interactive digital twin 320 can identify a subject of the query (i.e., context of the query), process the query for an answer, and return the answer in the form of text or speech “The air compressor is overheating.” The interactive digital twin 320 knows to return an answer based on context included in the query. In addition, the interactive digital twin 320 may also display a dashboard on a display of the user system 310. The dashboard may dynamically change based on operating conditions of the asset, questions asked by the user, answers provided by the interactive digital twin 320, and the like. In this example, the dashboard can be used to display metrics associated with the air compressor.

Next, the user 310 inputs a query “Has anything happened abnormal happened to the turbine in the last 24 hours?” In response, the interactive digital twin 320 may identify any components on the asset associated with the air compressor (i.e., within the original context) that are being modeled by the digital twin and which are acting abnormally. In this example, the interactive digital twin 320 determines that the condenser coils of the air compressor are operating below normal. Furthermore, the interactive digital twin 320 outputs metrics of the coils via a visualization on the display of the user system 310.

Next, the user submits a query “Any similar problems with other machines?” In response, the interactive digital twin remains within the original context of the previous conversation (e.g., air compressor, condenser coils, etc.) and identifies another machine that is having a problem with condenser coils and also identifies what that problem was. Here, the interactive digital twin 320 responds by stating “Yes, dirty condenser found in machine B.” The other problems can be any other machine that is related (type, location, class of devices, etc.). In addition, the interactive digital twin 320 may output similar problems and how they were resolved via the display of the user system 310.

Smart analytics can look/talk to other twins and look for similar patterns. Furthermore, the interactive digital twin 320 can traverse nodes and relationships of a knowledge graph representing the interactive digital twin and capture relationships (context). Sometimes a visualization being output may be a graph but often times the graph will be driving the visualization (not a graph) but the knowledge graph will be driving the answer that is output (words, text, speech, context, graphs, charts, etc.). The question/query would come in, and the answer would be based on the digital twin associated with a specific graph thereby providing context associated with the digital twin.

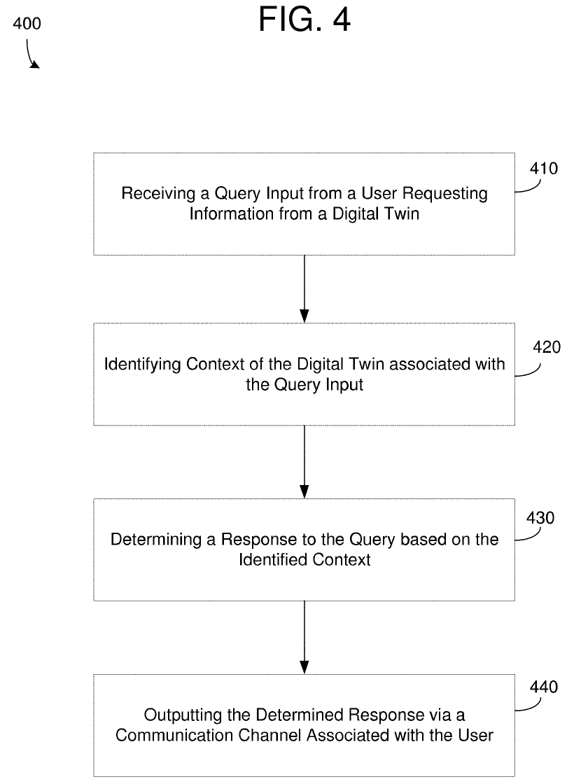

FIG. 4 illustrates a method 400 for managing an interactive digital twin in accordance with an example embodiment. The digital twin may include a virtual model of an asset, and the asset may include one or more of a hardware system, a software process, an actor, an information resource, and a combination thereof. Meanwhile, the method 400 may be performed by one or more of a computing node, a cloud instance, an on-premises system, an industrial computer, an asset controller, a user device, a stream processor, a database, a combination of devices, and the like, which may be part of or otherwise connected to an IIoT. Referring to FIG. 4, in 410, the method includes receiving a query input from a user via a user device (e.g., computer, audio, video, etc.). For example, the query input may include a request for information from or otherwise about a digital twin executing on a host platform. As a non-limiting example, the query input may include speech that is spoken by the user and input via an audio device such as a microphone, headset, telephone, smartphone, etc. As another example, the query may be input via a text message entered via a keyboard or other input means. The substance of the query may include a request for information about an operating performance being modeled by the twin.

In 420, the method includes identifying context of the digital twin that is associated with the query input, and in 430 the method includes determining a response to the query input based on the identified context. For example, the context identified in 420 may include information that is unique to an operating state of the particular digital twin (i.e., device ID, part ID, etc.) The identified context may include a component of the digital twin such as a part, a process, an actor, a resource, a manual, an instruction set, or the like, that is associated with the query input or is otherwise the answer to the query input. In this example, the determining the response in 430 may include generating a word or a phrase that provides knowledge about the component based on an operating state of the component.

In some embodiments, the digital twin may be stored as a template that has a structure of a knowledge graph. Within the knowledge graph, a hierarchical structure of nodes may be used to represent various components of the digital twin, and links between the nodes in the knowledge graph may represent hierarchical relationships between the components in the digital twin. In this example, the identifying the context may include identifying a knowledge graph representing the digital twin from among many different knowledge graphs associated with the system, and the determining the response may include traversing the knowledge graph to obtain knowledge about the operating state of the digital twin from one or more nodes, links, attached data structures, and the like, as the response.

As another example, context may be captured from a different digital twin than the digital twin being interacted with. For example, the identifying the context may include identifying other digital twins that have one or more of a period of time, a type, a location, and a class of service, that is in common with the digital twin, and requesting an operating pattern from at least one other digital twin. In this example, the response may be determined based on the context acquired from the other digital twin. Here, the interactive digital twin may communicate with other digital twins to share operating information. In this example, the determining the response may include identifying at least one other digital twin from among the other digital twins that has a common operating pattern as the digital twin, and generating a word or a phrase in response to the query input based on the operating pattern of the at least one other digital twin. Here, the common operating pattern in the other digital twin may provide insight to the user about what is happening with the present issue of the digital twin in question. Such context can significantly aid the user. Furthermore, the interactive digital twin can also provide information about how the problem with the other digital twin was solved providing the user with even more insight.

In 440, the method includes outputting the determined response from the digital twin via a communication channel that is capable of being received by the user. The communication channel may include an audio channel, a visual channel (e.g., video, display, etc.) a messaging channel, and the like. For example, the outputting the response may include outputting one or more of text, displays, and speech by the host platform executing the digital twin. As another example, the outputting my include outputting one or more visual representations such as a graph or a chart to a display to visually represent features such as the operating characteristic of the digital twin.

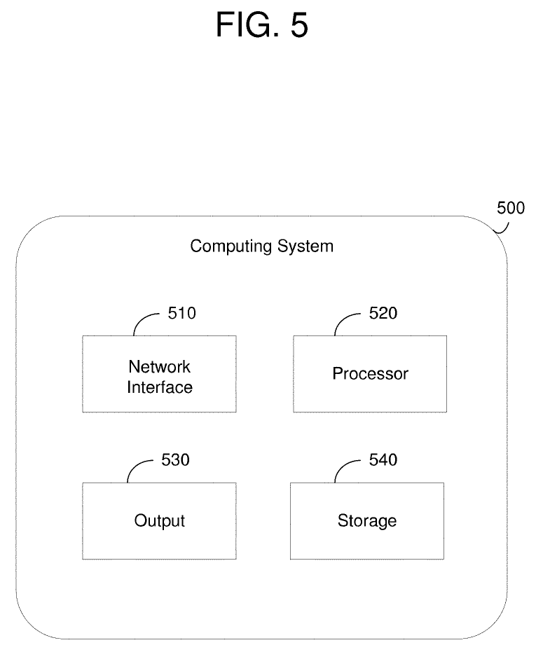

FIG. 5 illustrates a computing system 500 in accordance with an example embodiment. For example, the computing system 500 may be a user device, a cloud platform, a streaming platform, a server, an on-premises device, an industrial machine, an industrial server, an asset controller, and the like. As a non-limiting example, the computing system 500 may be the cloud platform 120 shown in FIG. 1. In some embodiments, the computing system 500 may be distributed across multiple devices. Also, the computing system 500 may perform the methods 400 of FIG. 4. Referring to FIG. 5, the computing system 500 includes a network interface 510, a processor 520, an output 530, and a storage device 540 such as a memory. Although not shown in FIG. 5, the computing system 500 may include other components such as an audio interface (e.g., microphone, speaker, etc.), a display, an input unit, a receiver, a transmitter, an application programming interface (API), and the like, all of which may be controlled or replaced by the processor 520.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like. The storage device 540 is not limited to a particular storage device and may include any known memory device such as RAM, ROM, hard disk, and the like, and may or may not be included within the cloud environment. In some embodiments, the storage 540 may include a graph database for storing templates of contextual digital twins and the associated elements thereof. The storage 540 may store software modules or other instructions which can be executed by the processor 520 to perform the methods described herein.

According to various embodiments, the processor 520 may receive a query input from a user via a user device. The query input may include a request for information from a digital twin executing on a host platform. The processor 520 may identify context of the digital twin that is associated with the query input. For example, the context may include information that is unique to an operating state of the digital twin. The processor 520 may further determine a response to the query input based on the identified context that is unique to the operating state of the digital twin. The output 530 may output the determined response from the digital twin via a communication channel that is capable of being received by the user. For example, the output may be a spoken response, a text message, a display, a combination thereof, and the like.

In some embodiments, the query input may include speech spoken by the user that is received via an audio interface, and the output 530 may output a response to at least one of a display and an audio device for outputting one or more of text and speech, respectively, as the response from the digital twin. In some embodiments, the processor 520 may identify a component of the digital twin associated with the query input, and determine the response by generating a word or a phrase that provides knowledge about the component based on an operating state of the component. According to various embodiments, the processor 520 may identify a knowledge graph representing the digital twin, and traverse the knowledge graph to obtain knowledge about the operating state of the digital twin as the response. In this example, the knowledge graph may include a hierarchical graph of nodes that represent a plurality of components of the digital twin and indicates relationships between the components.

In some embodiments, the processor 520 may identify other digital twins that have one or more of a period of time, a type, a location, and a class of service that is in common with the digital twin, and request an operating pattern from at least one other digital twin. In this example, the processor 520 may determine the response by identifying at least one other digital twin from among the other digital twins that has a common operating pattern as the digital twin, and generate a word or a phrase in response to the query input based on the operating pattern of the at least one other digital twin.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, interne of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a processor configured to receive a query input from a user via a user device, the query input comprising a request for information from a digital twin executing on a host platform, identify context of the digital twin that is associated with the query input, the context comprising information that is unique to an operating state of the digital twin, and determine a response to the query input based on the identified context that is unique to the operating state of the digital twin; and
an output configured to output the determined response from the digital twin via a communication channel that is capable of being received by the user.

2. The computing system of claim 1, wherein the digital twin comprises a virtual model of an asset, and the asset includes one or more of a hardware system, a software process, and a combination thereof

3. The computing system of claim 1, wherein the query input comprises speech that is received via an audio interface, and the output comprises at least one of a display and an audio device for outputting one or more of text and speech, respectively, as the response from the digital twin.

4. The computing system of claim 1, wherein the processor is configured to identify a component of the digital twin associated with the query input, and determine the response by generating a word or a phrase that provides knowledge about the component based on an operating state of the component.

5. The computing system of claim 1, wherein the processor is configured to identify a knowledge graph representing the digital twin, and traverse the knowledge graph to obtain knowledge about the operating state of the digital twin as the response.

6. The computing system of claim 5, wherein the knowledge graph comprises a hierarchical graph of nodes that represent a plurality of components of the digital twin and indicates relationships between the plurality of components.

7. The computing system of claim 1, wherein the processor is configured to identify other digital twins that have one or more of a period of time, a type, a location, and a class of service, that is in common with the digital twin, and request an operating pattern from at least one other digital twin.

8. The computing system of claim 7, wherein the processor is configured to determine the response by identifying at least one other digital twin from among the other digital twins that has a common operating pattern as the digital twin, and generate a word or a phrase in response to the query input based on the operating pattern of the at least one other digital twin.

9. The computing system of claim 1, wherein the processor is configured to determine the response by determining an operating characteristic of the digital twin, and control the output to output one or more of a graph or a chart to a display to visually represent the operating characteristic of the digital twin.

10. A computer-implemented method, comprising:
receiving a query input from a user via a user device, the query input comprising a request for information from a digital twin executing on a host platform;
identifying context of the digital twin that is associated with the query input, the context comprising information that is unique to an operating state of the digital twin;
determining a response to the query input based on the identified context that is unique to the operating state of the digital twin; and
outputting the determined response from the digital twin via a communication channel that is capable of being received by the user.

11. The computer-implemented method of claim 10, wherein the digital twin comprises a virtual model of an asset, and the asset includes one or more of a hardware system, a software process, and a combination thereof

12. The computer-implemented method of claim 10, wherein the query input comprises speech that is input via an audio device and the outputting the response comprises outputting one or more of text and speech by the host platform executing the digital twin.

13. The computer-implemented method of claim 10, wherein the identifying the context comprises identifying a component of the digital twin associated with the query input, and the determining the response comprises generating a word or a phrase that provides knowledge about the component based on an operating state of the component.

14. The computer-implemented method of claim 10, wherein the identifying the context comprises identifying a knowledge graph representing the digital twin, and the determining the response comprises traversing the knowledge graph to obtain knowledge about the operating state of the digital twin as the response.

15. The computer-implemented method of claim 14, wherein the knowledge graph comprises a hierarchical graph of nodes that represent a plurality of components of the digital twin and indicates relationships between the plurality of components.

16. The computer-implemented method of claim 10, wherein the identifying the context comprises identifying other digital twins that have one or more of a period of time, a type, a location, and a class of service, that is in common with the digital twin, and requesting an operating pattern from at least one other digital twin.

17. The computer-implemented method of claim 16, wherein the determining the response comprises identifying at least one other digital twin from among the other digital twins that has a common operating pattern as the digital twin, and generating a word or a phrase in response to the query input based on the operating pattern of the at least one other digital twin.

18. The computer-implemented method of claim 10, wherein the determining the response comprises determining an operating characteristic of the digital twin, and the outputting comprises outputting one or more of a graph or a chart to a display to visually represent the operating characteristic of the digital twin.

19. A non-transitory computer readable medium having stored therein instructions that when executed cause a computer to perform a method comprising:
receiving a query input from a user via a user device, the query input comprising a request for information from a digital twin executing on a host platform;
identifying context of the digital twin that is associated with the query input, the context comprising information that is unique to an operating state of the digital twin;
determining a response to the query input based on the identified context that is unique to the operating state of the digital twin; and
outputting the determined response from the digital twin via a communication channel that is capable of being received by the user.

20. The non-transitory computer readable medium of claim 19, wherein the query input comprises speech that is input via an audio device and the determined response comprises speech that is output by the host platform executing the digital twin.
